(19) United States
(12) Patent Application Publication
(10) Pub. No.: US 2002/0170599 A1
(43) Pub. Date: Nov. 21, 2002

(54) Rotating pig launcher

(76) Inventors: Malcolm Murhl Disher, Grande Prairie (CA); Ronald George Chernuka, Grande Prairie (CA)

Correspondence Address: BENNETT JONES, 4500 Bankers Hall East, 855 - 2nd Street SW, Calgary, AB, T2P 4K7, CA

(21) Appl. No.: 09/858,879

(22) Filed: May 17, 2001

(51) Int. Cl. B08B 9/057

(52) U.S. Cl. 137/269

(57) ABSTRACT

An apparatus for launching pigs is taught that is vertically compact, simple to operate, holds a plurality of pigs and which can accommodate various kinds of pigs. The launching is achieved by gravity. The apparatus for launching pigs includes a housing that can withstand at least the operating pressure of a pipeline, a supply magazine arranged in the housing with at least two pig-holding chambers, said pig-holding chambers being substantially vertical through-holes in the supply magazine, a closeable inlet port through the housing and providing access to the supply magazine, a launching chute connected to the pipeline and positioned beneath, as determined by gravity, the supply magazine, a drive operatively connected to the supply magazine, said drive causing the supply magazine to rotate about a substantially vertical axis and position the holding chamber generally above the launching chute.

### FIELD OF THE INVENTION

This invention relates to an apparatus for manual or automatic launching of pigs into a pipeline.

### BACKGROUND OF THE INVENTION

The movement of petroleum products through pipelines is complicated by the fact that substances deposit on the walls or bottom of the pipe. In gas pipelines, water and hydrocarbons such as paraffin condense to the liquid phase, and the condensate collects at points where the pipeline is low relative to neighboring sections of pipeline. The production of condensate is a problem that is particularly acute in colder environments. By forming obstructions in the pipe, condensates, deposits and sediment reduce the efficiency of a pipeline by causing increases in pressure and a reduction in flow.

Pipelines are therefore regularly cleaned of deposits, condensates and other debris that may be present by use of a cleaning device commonly known as a “pig”. Pigs are passed through the pipeline along with the flowing gas, which provides the pressure for forward momentum of the pig. The pig pushes ahead of it any foreign material that would obstruct the flow through the pipeline. The pig and the collected material is removed from the pipeline at various intervals.

Pipeline pigs can also be used for product separation, measuring volumes and velocities, to actuate signals and controls, for meter calibration and for testing of pipelines. An ideal pigging system, whether used for cleaning or otherwise, will get pigs into and out of the pipeline without flow interruption.

Various types of pigs have been described, such as spheres and cylinders, line scrapers, bullets, and cup pigs. As well, various devices for launching pigs into pipelines have been disclosed in a number of US Patents, including U.S. Pat. Nos. 4,073,303 to L. E. Foley; 4,401,133 to R. J. Lankston; 4,435,872 to V. Leikam; 4,709,719 to J. Littleton and G. W. Davis; 5,139,576 to G. W. Davis; 5,873,139 to G. Goth; 6,022,421 to W. R. Bath and C. R. Yemington, and 6,079,074 to J. R. Ellett.

Many of these pig launching apparatuses use a storage mechanism that stacks pigs one on top of the other which causes unsafe height problems. See for example, U.S. Pat. Nos. 4,709,719, 6,079,074 and 6,022,421. When pigs are stacked in this manner, there is also the possibility that two or more pigs would be launched into the pipeline at the same time. If the storage mechanism stores pigs horizontally, then the launching mechanism is often more complex as gravity alone will not suffice for launching the pigs. See for example U.S. Pat. No. 5,873,139. In yet other designs, the pig launching apparatus is designed in such a way that it only works with a particular style of pig, which limits the adaptability of the apparatus to new situations. See for example U.S. Pat. Nos. 4,401,133; 4,435,872; 4,709,719. Therefore there is a need in the industry for a pig launching apparatus that is vertically compact, simple to operate and which can accommodate various kinds of pigs.

### SUMMARY OF THE INVENTION

It is thus the aim of this invention to provide an apparatus for launching pigs that is vertically compact, simple to operate, automatic, launches pigs by gravity, holds a plurality of pigs and which can accommodate various kinds of pigs.

There is therefore provided an apparatus for launching pigs into a pipeline comprising a housing that can withstand at least the operating pressure of a pipeline, a supply magazine arranged in the housing with at least two pig-holding chambers, said pig-holding chambers being substantially vertical through-holes in the supply magazine, a closeable inlet port through the housing and providing access to the supply magazine, a launching chute connected to the pipeline and positioned beneath, as determined by gravity, the supply magazine, a drive operatively connected to the supply magazine, said drive causing the supply magazine to rotate about a substantially vertical axis and position the holding chamber generally above the launching chute.

It is thus a feature of this invention to provide an apparatus that uses gravity to introduce a pig into a pipeline. This invention avoids the complexity of using pushing devices, valves or levers to position a pig or to launch a pig into a pipeline. Further, this invention enables the release of pigs in a controlled manner with little risk of inadvertently releasing more than one at a time.

In a preferred embodiment of this invention, the supply magazine is a generally circular disk with a plurality of holding chambers spaced in an organized way about the disk so that the holding chambers can each in turn be positioned over the pig launching chute such that any pigs contained therein can drop by gravity into the chute. Thus the supply magazine functions both in pig storage and pig delivery to the pipeline. In this embodiment many pigs can be loaded into the supply magazine at once, which provides a savings in manpower time as only infrequent visits to the pig launcher are necessary. Further, because the disk is oriented on a generally horizontal plane the apparatus is vertically compact which avoids the height problems that are encountered in vertical storage mechanisms.

In another embodiment of this invention, two supply magazines are used to increase pig storage capacity. In this embodiment an upper supply magazine is positioned above a lower supply magazine, such that pigs from the holding chambers in the upper supply magazine automatically drop into or through the holding chambers of the lower supply magazine upon rotation of the upper supply magazine. The pigs in the lower supply magazine successively drop into the pipeline upon rotation of the lower supply magazine.

The supply magazine can be any desired shape that will permit carriage of pigs and positioning of the pigs individually over the chute by rotation of the magazine. In particular, the supply magazine can be generally circular, square, rectangular or oblong members journalled to rotate about a generally vertical axis.

Preferably, the launcher includes a closable valve to isolate the interior of the housing from the pipeline. The valve can be located in or below the launching chute. Preferably, the housing also has a blow-down valve that is used to depressurize the housing once the isolation valve is closed and before the housing is opened. In one embodiment, access to the supply magazine for the loading of pigs is gained by opening a quick closure on the inlet port.

Preferably, the holding chambers are formed to accommodate many of the kinds of pigs used in pipeline operations. The apparatus includes a floor under the supply magazine on which the pigs rest when in their holding chambers. The floor is open to the launching chute and prevents the pigs from dropping out of their holding chambers until they are positioned over the launching chute. Thus, the pigs are maintained in their holding chambers until they are pushed over the launching chute by rotation of the supply magazine. This arrangement, which is not dependent on the length, shape, weight or composition of the pigs being used, can accommodate various kinds of pigs without modification. Further the apparatus can be modified to accommodate changes in the dimensions of the holding chambers that might be required to accommodate any pigs that are not or would not be able to be launched by the preferred embodiment described herein.

The supply magazine can be rotated by many different means, including manually, electrically, pneumatically or by hydraulics. In a preferred embodiment a drive mechanism that is pneumatically operated is used, which allows the apparatus to be used in a remote location with only a small power source.

The launching process, and in particular, the drive can be actuated either manually or automatically. A preferred embodiment of this invention provides a drive mechanism that is actuated remotely. This allows the launching of a pig into the pipeline as needed but precludes the necessity of travel to the site in order to do so. In yet another embodiment the drive mechanism is actuated on a timer to deliver a pig to the pipeline on a regular basis.

### BRIEF DESCRIPTION OF THE DRAWINGS

FIG. 1 is a perspective view of a pipeline pig launching apparatus according to the present invention partially cut away to show a supply magazine, in section along line I-I of FIG. 2. The apparatus is shown mounted on a valve assembly and a pipeline.

FIG. 2 is a top plan view of pipeline pig launching apparatus of FIG. 1.

FIG. 3 is a cross sectional side view of a supply magazine useful in the present invention. The section is taken along line III-III of FIG. 4b.

FIG. 4a is a top plan view the center support plate of the supply magazine of FIG. 3.

FIG. 4b is a sectional view along line IV-IV of FIG. 3.

FIG. 5 is a top plan view of a rotation mechanism useful in the present invention.

FIG. 6 is a side perspective view of the rotation mechanism of FIG. 5.

FIG. 7A is a perspective view of another pipeline pig launching apparatus according to the present invention partially cut away to show a supply magazine, in section.

FIG. 7B is a schematic top plan view of the apparatus of FIG. 7A showing the positions of the pig launching chute, the inlet port and the access opening between the upper and lower magazines.

### DETAILED DESCRIPTION OF PREFERRED EMBODIMENTS

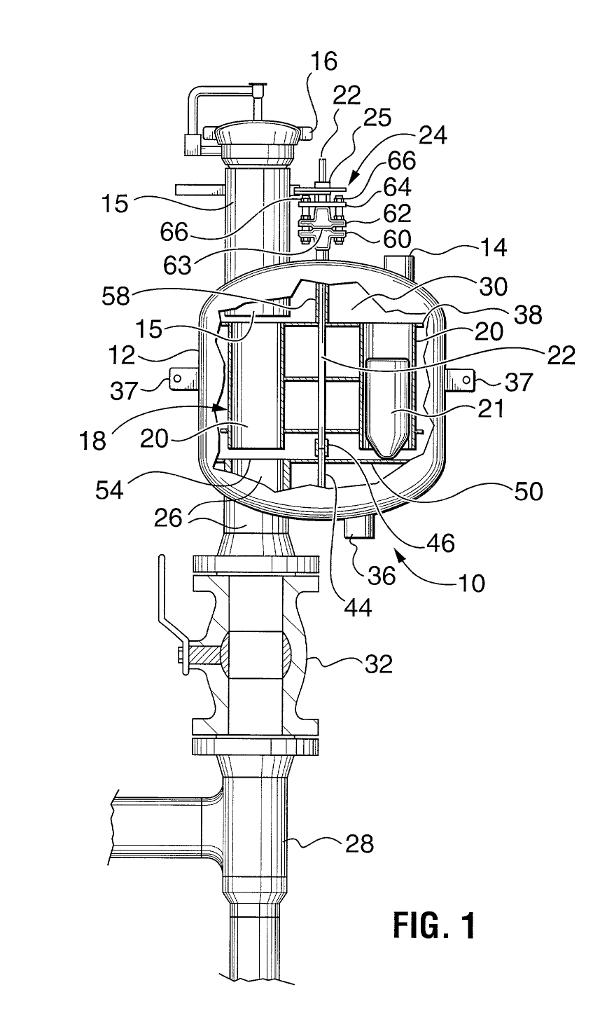

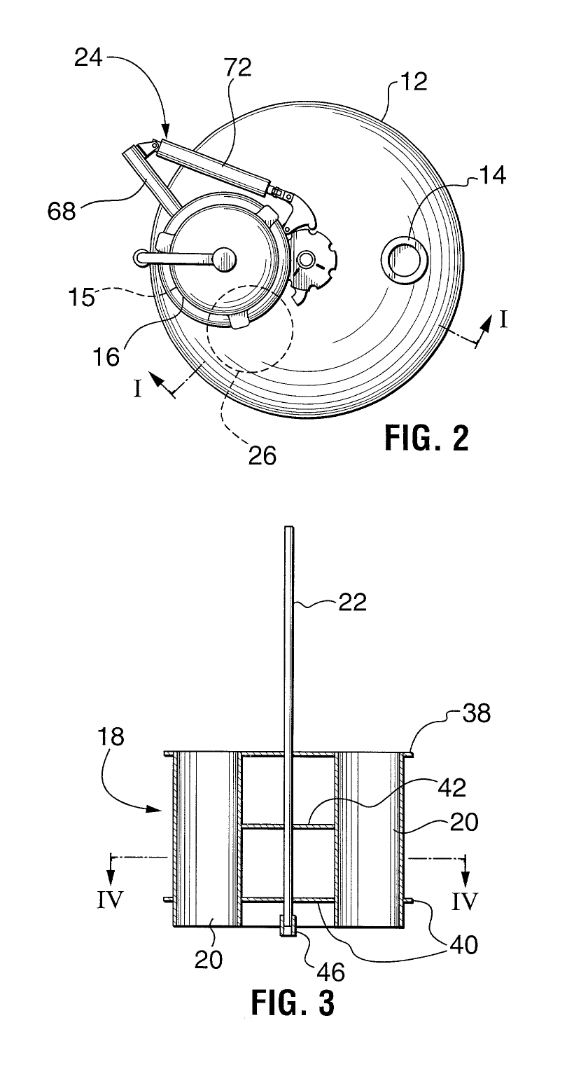

FIGS. 1 and 2 show a pig launching apparatus 10 of this invention including a housing 12, a pressure release valve 14, a pig inlet 15 with a quick loading closure 16, a supply magazine 18 including a plurality of holding chambers 20 preferably for each accommodating one pig 21 and a rotation shaft 22, a rotation mechanism 24 for rotating the rotation shaft of the magazine and a pig launching chute 26. Apparatus 10 is in communication with a pipeline 28 through pig launching chute 26.

Housing 12 can be any shape that will accommodate supply magazine 18 and allow supply magazine 18 to rotate about a generally vertical axis within housing 12. The housing is preferably constructed of carbon steel, but can be made with any suitable material that will enable housing 12 to withstand the fluid pressures associated with an operating pipeline, since when the pig launching apparatus is in operation, the pressure in internal chamber 30, within housing 12 is equal to the pressure in pipeline 28.

To permit isolation of internal chamber 30 of housing 12 from pipeline 28, as will be necessary when opening the housing, a valve 32, such as a ball valve, is provided between pig launching chute 26 and the pipeline. The valve can be a part of the existing pipeline or can be installed with the apparatus of the present invention. A pressure release valve 14 is also provided to release the pressure in the internal chamber once valve 32 is closed.

Pigs are loaded to the supply magazine through pig inlet 15. The pig inlet is positioned above, as determined by gravity, supply magazine 18 and the supply magazine is rotatable such that the holding chambers can each, in turn, be aligned with the pig inlet to accept a pig therein. Thus, the pigs can be dropped through the pig inlet and loaded by gravity into the holding chambers. Pig launching chute 26, shown in phantom in FIG. 2, is offset from pig inlet 15 such that once a pig is placed into a particular holding chamber of supply magazine 18, the pig can only be released into the pipeline by rotating magazine 18 until that holding chamber is positioned over chute 26.

A floor 50 is positioned directly below supply magazine 18 and prevents, by obstruction, pigs from dropping out of the holding chambers 20. When stored in the magazine, the pigs rest on the floor and extend up into their holding chambers. Upon rotation of the magazine, the pigs stored therein are pushed over the surface of floor 50. Floor 50 includes an opening 54 positioned above pig launching chute 26, said opening 54 being sufficiently large and correctly positioned to enable a pig to drop from an aligned one of the holding chambers into pig launching chute 26 when the rotation mechanism 24 positions one of the holding chambers above pig launching chute 26. The lower ends of the holding chambers extend down to a point just above floor 50. The gap therebetween is selected to be insufficient to allow the pig to jam therein.

On the bottom of housing 12 is drain valve 36, which can be opened to release any fluid that may be trapped in housing 12. On either side of housing 12 are support tabs 37 which are used to hold pig launching apparatus 10 in place at the site where it is installed.

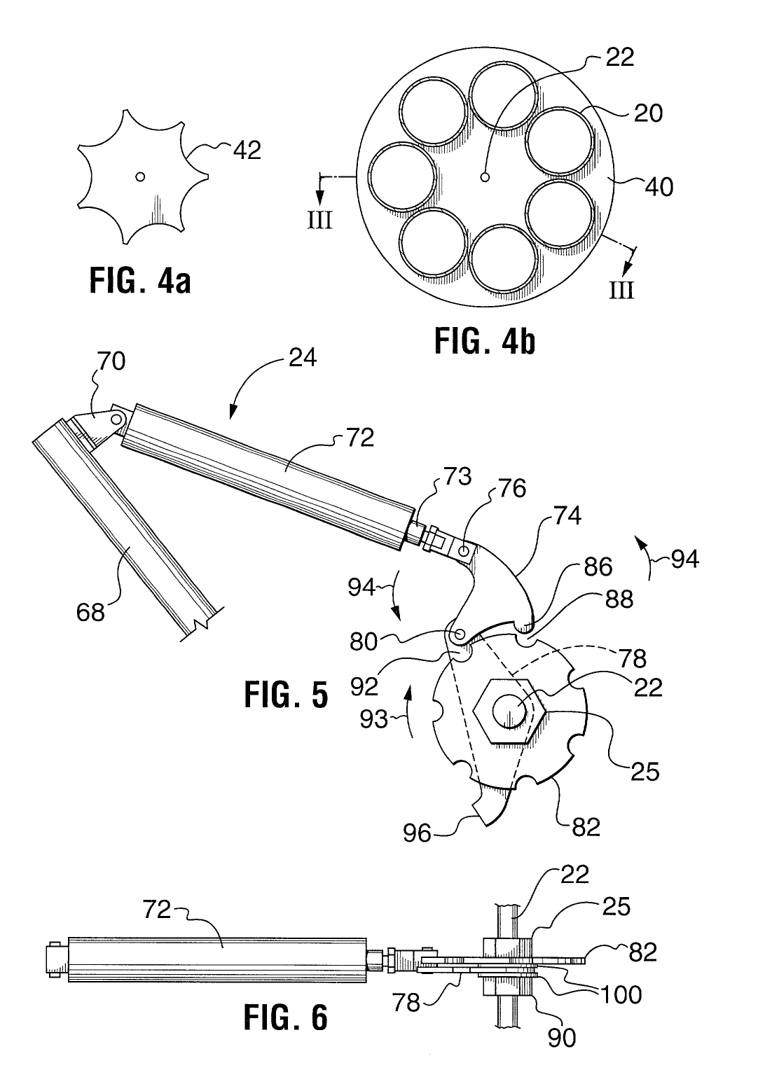

FIGS. 3 and 4 show a preferred embodiment of supply magazine 18, which includes an upper support plate 38, a lower support plate 40, a center support plate 42 and seven holding chambers 20 equally spaced about a centrally located rotation shaft 22.

Holding chambers 20 are formed as generally cylindrical tubes extending between at least the upper support plate and the lower support plate. A cylindrical tube is particularly useful as it will accommodate various kinds of pigs. In particular, the diameter of a pig which is useful in a particular pipeline is generally fixed based on the diameter of the pipeline. Thus, the diameter of the holding chambers will be readily selectable depending on the pipeline on which the apparatus is to be used. In particular, a holding chamber should have a diameter slightly larger than the pig to be launched therefrom. This permits the pig to sit loosely in the chamber, without engaging therein but prevents a longer pig from tipping over in the chamber and becoming jammed therein or in the launching chute.

While the diameter of a pig may be generally fixed for any pipeline, the length and shape of the pig may vary and the cylindrical tube form of the present holding chamber can accommodate various lengths and shapes of pigs without changing the functioning of the apparatus. It will be appreciated, however, that the dimensions and number of holding chambers 20, and the dimensions of supply magazine 18 can be modified to conform to the size or type of pig that is to be used in any particular pipeline.

Support plates 38, 40 and 42 are used to position and secure holding chambers 20 in a generally vertical position. Holding chambers 20 are attached to upper, center and lower support plates 38, 40 and 42, as by welding. Rotation shaft 22 is rigidly connected, as by welding, to support plates 38, 40 and 42 and includes a guide collar 46 at its lower end. Support plates 38, 40 and 42, holding chambers 20 and shaft 22 are preferably constructed of stainless steel. The magazine is preferably stress relieved at least once during manufacture. It will be appreciated that there may be other designs of support plates, which perform the functions of spacing holding chambers 20 and maintaining holding chambers 20 in a substantially vertical position. These alternate designs are intended to be included herein. However, this illustrated arrangement has been found to substantially eliminate twisting of the structure during manufacture, for example during the stress relieving process.

Supply magazine 18 can be constructed in other ways to achieve the same result of positioning substantially vertical holding chambers 20 about a central rotation point. For instance, rather than using support plates 38, 40 and 42 to hold and position holding chambers 20, supply magazine 18 can be constructed from a solid and generally circular disk, through which vertical through holes are drilled for holding chambers, the through holes being spaced in a way that will permit regulated pig launching through the pig launching chute.

For simplicity of operation, preferably the holding chambers are substantially equally spaced apart and spaced equally from the axis of rotation. As such, the rotation mechanism need only rotate the magazine a known degree for each launch and the launching chute can be positioned directly below the holding chambers so that the pigs drop directly into the chute. However, it is to be understood that other arrangements of holding chambers can be accommodated by adjusting the rotation mechanism or funneling the opening to the chute.

In addition, in order to function in this invention, supply magazine 18 need not be substantially circular and holding chambers 20 and/or the axis of rotation need not be close to vertical. For example, a supply magazine that is square, rectangular, notched or oval will also function within the scope of this invention, provided that supply magazine can be rotated to successively and controllably drop pigs into the pig launching chute by gravity. In addition, holding chambers 20 and the axis of rotation need only be vertically oriented enough to permit pigs contained therein to drop with the force of gravity, into pig launching chute 26, when a holding chamber is positioned above the chute, or generally above it. These alternate designs are intended to be included in the scope of this invention.

Referring again to FIG. 1, rotation shaft 22 extends through the housing and up to rotation mechanism. Rotation shaft 22 at its upper end is attached to rotation mechanism 24 via a rotator hub 25. Therefore, when rotator hub 25 is turned by rotation mechanism 24, shaft 22 and supply magazine 18 rotate with it.

Magazine 18 is supported on a support rod 44 extending up from the housing. In particular, guide collar 46 of the shaft nests over the tip of support rod 44. Shaft 22 is journalled between rod 44 and a collar 58, which is aligned with an opening through housing. Collar 58 is welded to housing 12 and is hollow, thus enabling rotation of shaft 22 therein. Collar 58 extends down to an end disposed just above upper support plate 38, and also functions to hold supply magazine 18 against movement upwardly in the housing. In particular, when operating the apparatus, the pressure from pipeline 28, especially when opening valve 32, will sometimes tend to force supply magazine 18 upwards. However, collar 58 will maintain the magazine in position by abutment thereagainst.

The upper end of collar 58 extends out through housing 12 and is welded to a flange 60. A packing gland 62 is mounted above flange 60 and a seal 63 is disposed therebetween. Packing material in packing gland 62 is compressed therein by packing gland follower 64 to form a tight seal about shaft 22 so that the pressure in housing 12 is maintained. Bolts 66 secure packing gland 60 and packing gland follower 64 to flange 60 and thereby to the top of housing 12. Bolts 66 can be tightened to adjust the seal provided by packing gland 62.

Referring now to FIGS. 2, 5 and 6, a rotation mechanism 24 useful in the present invention is shown. Rotation mechanism 24 provides a means for rotating the magazine in regular intervals corresponding with the position of each holding chamber relative to the pig launching chute. In the illustrated embodiment, the rotation of magazine 18 is driven pneumatically and the rotation device includes a pneumatic cylinder 72 secured to a stationary support, i.e. a cylinder support 68 secured to pig inlet 15. The use of a pneumatic drive is preferred for use in the present apparatus, as it can be operated for long periods with a small power source such as an automobile battery. Thus, the present pig launching apparatus can be used in remote locations away from power lines.

Pneumatic cylinder 72 is attached by a hinge 70 to pneumatic cylinder support 68 and cylinder rod 73 is connected to an outer linkage plate 74 at pivot 76. Outer linkage plate 74 is in turn connected to an inner linkage plate 78 at pivot 80. Inner linkage plate is connected to shaft 22 but is free to rotate thereabout as limited by outer linkage plate 74 and cylinder 72. As moved by extension and retraction of cylinder rod 73, the assembly of cylinder 72, outer linkage plate and inner linkage plate 78 is moveable in parallel planes in an arc about shaft 22.

Outer linkage plate 74 includes a protrusion 86 that is engagable into an aligned one of the notches 88 on a notched rotator plate 82. Inner linkage plate 78 is shown partly in phantom in FIG. 5 as it is positioned beneath both outer linkage plate 74 and notched rotator plate 82. Rotator hub 25 is rigidly secured, as by welding, to notched rotator plate 82 and rigidly secured to rotation shaft 22 preferably by a keyway or set screws. Thus, any movement of plate 82 or rotator hub 25 is directly translated to shaft 22. A nut 98 threads onto the shaft below inner linkage plate 78 to secure all linkage components together. However, spacing washers 100 eliminate friction between linkage components and isolates movement of inner linkage plate 78 from rotator plate 82 and shaft 22, except through outer linkage plate 74.

The notches 88 on notched rotator plate 82 correspond with the positions of the holding chambers in the magazine. In particular, preferably, the notches are arranged similarly to, and of a number equal to the number of, holding chambers in the magazine, such that when protrusion 86 is engaged in a particular notch, one corresponding holding chamber will be positionable over pig launching chute 26.

In FIG. 5, the rotation mechanism is shown in a disengaged position wherein rod 73 is fully retracted and protrusion 86 is not engaged in any notch. In this position, the shaft is not driven by the mechanism and the shaft can be rotated manually. This position is the normal operating position for the mechanism between advancing the magazine and is the position necessary for loading pigs to the magazine. In particular, during loading of pigs, it is desirable to rotate the magazine manually to align the holding chambers with pig inlet. Rotator hub 25 is preferably formed as a hex to facilitate manual rotation of the shaft.

During use, the notched rotator plate 82 is moved to rotate by protrusion 86 engaging in a notch and the cylinder rod being extended to push the outer linkage plate 74 forward and, as limited by inner linkage plate 78, to rotate the shaft. In particular, in one advancement cycle, rod 73 is first extended so that protrusion 86 is moved from the position shown in FIG. 5 to a position wherein it is engaged in a notch 88. In this position, a holding chamber will be disposed over pig launching chute 26. That holding chamber will be empty having already dropped the pig, once contained therein, into the pipeline. To advance the magazine so that the next holding chamber is located over the pig launching chute and to release another pig into the pipeline, rod 73 is further driven to extend which causes outer linkage plate 74 to pivot around hinge 76 and pivot 80 and move in a direction as indicated by arrow 93. Since the connection to between outer linkage plate 74 and inner linkage plate 78 restricts the outer linkage plate to move in an arc about shaft 22, the protrusion remains in notch 88 and drives rotator plate 82 to rotate, also in the direction indicated by arrow 93. Once the rod reaches the outer extent of its travel, the cylinder then begins to retract rod 73. The outer extent of rod travel can be set by adjustment of the rod itself or by abutment of inner linkage plate 78, for example at free end 96, against a stationary object such as inlet 15. The frictional resistance to pivotal motion about pivot 80 is selected to be less than that of inner linkage plate 78 about shaft 22 such that when the rod is retracted, the outer linkage plate will first pivot about pivot 80 and pull protrusion 86 out of the notch in which it was located substantially without rotating plate 82. The rod will continue to retract to a position shown in FIG. 5, moving inner linkage plate 78 and outer linkage plate in a direction indicated by arrow 94. The mechanism will remain in the position as shown in FIG. 5 until it is receives a signal to repeat the cycle to advance the magazine, at which point the protrusion will be advanced and engage in the next adjacent notch, in the drawing this notch is indicated as 92. As will be appreciated, the rod, and corresponding configurations of plates 74, 78 and 82 must be selected to provide proper advancement of the magazine and alignment of the protrusion with the next adjacent notch on the return cycle.

Although shaft 22 can be rotated manually, it is generally resistant to rotation. Therefore, although protrusion 86 is not normally engaged in a notch, the magazine tends not to rotate on its own. If it should occur that the rotator plate has been rotated between cycles and the protrusion does not directly align with a notch when it is advanced, the protrusion will tend to be driven along the outer edge of rotator plate 82 until it drops into a notch and will then begin to turn the shaft.

Cylinder 72 can be actuated to move through its cycle of extension and retraction by any suitable means such as a timing device, remote control or manual actuation of a switch on the apparatus. The cylinder is attached to a fluid pressure device such as a nitrogen tank, compressed air and/or pump.

In the illustrated embodiment, rotation mechanism 24 drives supply magazine 18 to rotate in a clockwise direction. However, by simple modification rotation in a counterclockwise direction can be achieved.

To reload supply magazine 18 with pigs, ball valve 32 is closed to isolate internal chamber 30 from pipeline 28 and pressure in internal chamber 30 is released by opening pressure release valve 14 before opening quick loading closure 16. Since protrusion 86 is normally disengaged from notch 88, supply magazine 18 can be manually rotated within housing 12, in either orientation. Manual rotation can be effected by turning shaft 22 or rotator hub 25.

The procedure to reload the magazine with pigs will be dependent on the relative positions of the pig inlet 15 and pig launching chute 26. In the illustrated embodiment, the pig inlet is positioned to load into the holding chamber directly clockwise from the one located over the pig launching chute. Thus, to reload the apparatus of the illustrated embodiment, it is first rotated counterclockwise to count the number of empty holding chambers therein. The magazine may contain some pigs or be entirely empty. Counterclockwise rotation is discontinued when an occupied holding chamber 20 is located or when it is determined that the magazine is completely empty. Then supply magazine 18 is rotated clockwise and, beginning with the first empty holding chamber, one pig is dropped through pig inlet 15 into the empty holding chamber aligned therebelow. Supply magazine 18 is then advanced clockwise so that the next empty holding chamber 20 aligns with inlet port 15 and one pig is dropped through the pig inlet into that holding chamber. This process is repeated until all, or all but one, of the empty holding chambers 20 have been charged with one pig each. In particular, during reloading the holding chamber 20 that, after loading is completed, is positioned directly above pig launching chute 26 can be left empty. Alternately, if it is desired to launch a pig into the pipeline immediately after reloading, pigs can be loaded into all empty holding chambers 20, which will result in the pig from the holding chamber directly over pig launching chute 26 dropping into the chute and resting on top of valve 32. As will be appreciated, it will be necessary to know the total number of holding chambers in the magazine and the number of empty holding chambers prior to reloading in order to properly reload the device, since if a loaded holding chamber is rotated over the chute prior to being rotated under the pig inlet, it would appear empty although the pig loaded thereto had just dropped into the launching chute. In the embodiment shown in FIG. 3B, a maximum of seven pigs could be loaded into empty supply magazine 18.

In the preferred embodiment, the pig inlet is positioned to load into the holding chamber directly beside the one located over the pig launching chute. Thus, it is easy to load the magazine leaving just the holding chamber over launching chute 26 empty. In addition, when looking into the pig inlet, pig launching chute 26 can be seen on the other side of the supply magazine, and it is possible to determine whether or not there is a pig located in the chute.

After loading the magazine, closure 16 is closed and sealed and valve 32 is opened. When ball valve 32 is opened after the loading operation, any pig in pig launching chute 26 will enter the pipeline immediately.

Although this invention will enable pigs to be launched into pipelines using gravity alone, it may be desirable to use pressure in addition to gravity, to launch a pig. This may be useful where a pig is stuck in the holding chamber or in the launching chute. Therefore, in an alternative embodiment of pig launching apparatus 10, additional external pressure is introduced into housing 12 via a pressurization nozzle (not shown) contained therein. This additional pressure is applied to the top of the pig and forces it into the pipeline.

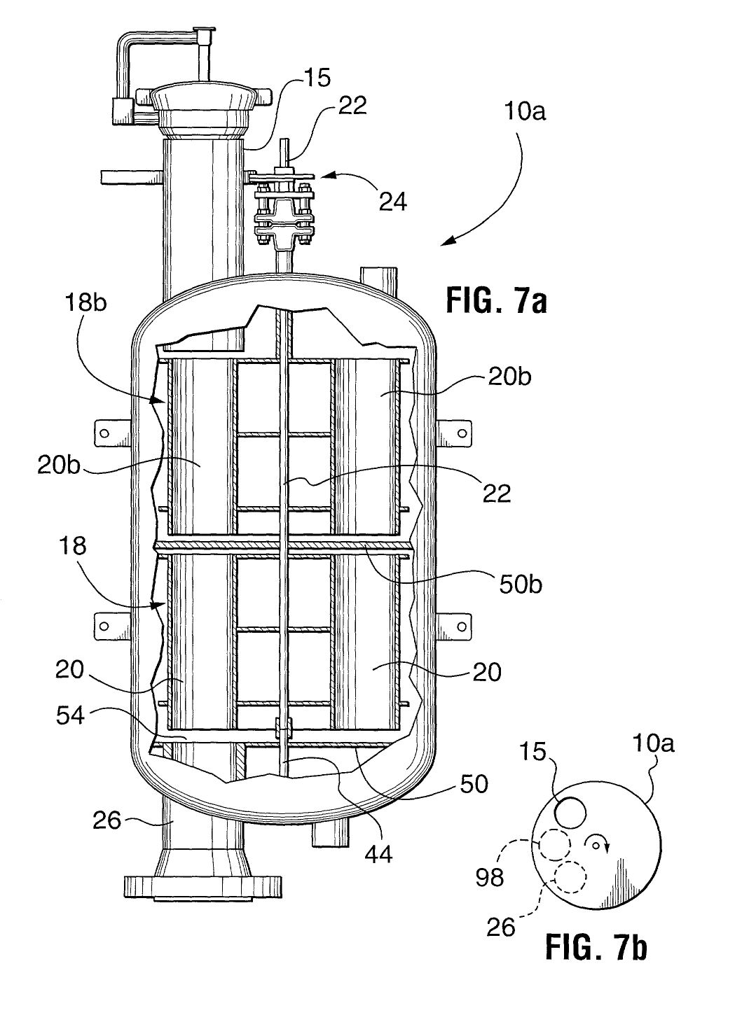

FIGS. 7A and 7B show an alternative embodiment of this invention that increases the storage capacity of pig launching apparatus 10a. In this embodiment, a second supply magazine 18b is positioned above the first supply magazine and a second floor 50b is positioned between supply magazines 18 and 18b to support the pigs in supply magazine 18b. Supply magazine has holding chambers 20 and supply magazine 18b has holding chambers 20b. To simplify operation and manufacture of the launching apparatus, the holding chambers in each magazine are similar in number and position.

In this embodiment, rotation shaft 22 rotates both magazines 18 and 18b simultaneously. Shaft 22 has a rotation mechanism 24 in driving communication therewith.

To permit loading and unloading of the two magazines, an opening 98 is positioned in floor 50b that is one holding chamber position clockwise from pig launching chute 26 and inlet 15 is aligned with the holding chamber that would be two positions clockwise from the holding chamber aligned above pig launching chute 26. With this configuration, both supply magazines can be loaded with pigs by turning the shaft, and attached magazines, clockwise, as indicated by the arrow in FIG. 7B. Continued clockwise turning of shaft will unload the pigs from magazine 18 into launching chute 26 one-by-one. As the supply of pigs in bottom magazine 18 is launched, the upper supply of pigs from magazine 18b will drop one-by-one to refill the lower magazine.

The apparatus of FIG. 7A with two magazines, each including seven holding chambers, will hold 12 or 13 pigs, depending on whether or not one is dropped into the pig launching chute during the loading process. The upper holding chamber above opening 98 should remain empty during the loading process, to avoid jamming of pigs between the magazines and the opening.

Of course, the apparatus could be operated in a counterclockwise direction by aligning the inlet port and the floor opening on the other side of the pig launching chute.

It will be apparent that many other changes may be made to the illustrative embodiments, while falling within the scope of the invention and it is intended that all such changes be covered by the claims appended hereto.

1. An apparatus for launching pigs into a pipeline comprising:
(a) a housing;
(b) a supply magazine in the housing;
(c) at least two holding chambers in the supply magazine, said holding chambers being substantially vertical through-holes in the supply magazine and each formed to accommodate a pig;
(d) a closeable inlet port through the housing and providing access to the supply magazine;
(e) a floor positioned below the supply magazine to support any pigs contained within the holding chambers of the supply magazine;
(f) a launching chute connected to the pipeline and opening through the floor beneath the supply magazine; and
(g) a drive operatively connected to the supply magazine, said drive causing the supply magazine to rotate about a substantially vertical axis and position the holding chambers successively above the launching chute.

2. An apparatus according to claim 1 wherein the housing is able to withstand at least the pressure of an operating pipeline.

3. An apparatus according to claim 1 wherein the supply magazine comprises a disk.

4. An apparatus according to claim 1 wherein the drive operates by pneumatics.

5. An apparatus according to claim 1 comprising a pressurization nozzle said pressurization nozzle enabling the pressure inside the housing to be increased.

6. An apparatus for launching pigs into a pipeline comprising:
(a) a housing;
(b) an upper supply magazine and a lower supply magazine;
(c) at least two holding chambers in the upper supply magazine and at least two holding chambers in the lower supply magazine, said holding chambers being substantially vertical through-holes in the upper supply magazine and the lower supply magazine;
(d) the upper supply magazine being positioned above the lower supply magazine such that the holding chambers of the upper supply magazine successively communicate with the holding chambers of the lower supply magazine;
(e) a floor positioned above the lower supply magazine and below the upper supply magazine to support any pigs contained within the holding chambers of the upper supply magazine;
(f) an opening through the floor permitting access from the upper supply magazine and the lower supply magazine, the opening sized to permit a pig from a holding chamber of the upper supply magazine to drop therethrough into an aligned holding chamber of the lower magazine, when a holding chamber of the upper supply magazine is aligned over the opening;
(g) a drive operatively connected to the upper supply magazine, said drive causing the upper supply magazine to rotate about a substantially vertical axis and position the holding chambers in the upper supply magazine successively above the opening;
(h) a launching chute connected to the pipeline and positioned beneath the lower supply magazine and out of alignment with the opening in the floor, and
(i) a drive operatively connected to the lower supply magazine, said drive causing the lower supply magazine to rotate about a substantially vertical axis and position the holding chambers in the lower supply magazine successively above the launching chute.

7. An apparatus according to claim 6 wherein the housing is able to withstand at least the pressure of an operating pipeline.

8. An apparatus according to claim 6 wherein the supply magazine comprises a disk.

9. An apparatus according to claim 6 wherein the drive operates by pneumatics.
